(19) United States
(12) Patent Application Publication
(10) Pub. No.: US 2020/0330938 A1
(43) Pub. Date: Oct. 22, 2020

(54) MIXING APPARATUS FOR VERY SMALL VOLUME FORMULATIONS

(71) Applicant: Vijay SINGH, Far Hills, NJ (US)

(72) Inventor: Vijay SINGH, Far Hills, NJ (US)

(21) Appl. No.: 16/386,958

(22) Filed: Apr. 17, 2019

(51) Int. Cl. B01F 11/00; A61J 1/20; B01F 15/00; B01F 15/02

(52) U.S. Cl. CPC B01F 11/0051; A61J 1/20; B01F 11/0048; A61J 1/10; B01F 15/026; B01F 15/00207; B01F 15/0085

(57) ABSTRACT

Systems, methods, and devices are provided for mixing very small volumes of liquids, creams, and ointments. The system includes a mixing apparatus and a flexible tube in ingredients can be added to a base formulation via a connector. The mixing apparatus can mix the contents of the tube non-invasively.

### FIELD

The presently disclosed embodiments relate generally to devices, systems, and methods of mixing very small volumes of liquids, creams, and ointments.

### BACKGROUND

Advances in health and beauty care have led to the development of personalized treatments. In these applications, a very small amounts of beauty or medical formulation is made specifically for an individual. The formulation may contain ingredients specially formulated for a particular customer. For example, a color-balanced makeup may be created instantly to exactly match skin color. One of the barriers to the more widespread adoption of personalized beauty and health care are the lack of methods and equipment to make very small formulations on demand. Formulations are currently done by mixing ingredients in stainless-steel vats with motor-driven mixing blades. These cumbersome vessels are typically designed for a minimum formulation volume of several liters and must be cleaned and sterilized between each formulation. This batch size is far too large for personalized formulations which are typically 5 ml to 100 ml. Cleaning and sterilization requirements do not enable current technology to be scaled down. Thus, no technology currently exists for compounding and mixing very small volume formulations. Especially under sterile conditions. Even more useful would be a technology that enables this to be done at point-of-use—for example at the beauty counter in a department store.

### SUMMARY

According to some embodiments, a mixing system may be provided for mixing small volume formulations at a point-of-use center. The mixing system may include a flexible tube comprising a volume of a base formulation that is less than a volume of the flexible tube. The system may also include a connector configured for one-way introduction of one or more external ingredients into the flexible tube while maintaining a sterile condition inside the flexible tube. Means for mixing the base formulation and the one or more external ingredients by applying a predetermined and varying pressure from one end of the flexible tube to another end so that the resulting formulation is uniform.

In some embodiments, the means for mixing may comprise two rollers coupled to a motor and configured to provide rolling pressure from one of the flexible tube to the other end of the flexible tube. In some embodiments the means for mixing may further comprising a camera configured to-sense homogeneity of the mixture to stop the motor and corresponding movement of the rollers when the resulting formulation is determined to be uniform.

In some embodiments, the two rollers are fixed in a vertical plane and the flexible tube is suspended and supported by the rollers, wherein in response to the rollers moving in one direction, the flexible tube moves in a direction opposite the one direction. In some embodiments, the flexible tube is fixed in a vertical plane via a clamping mechanism, and two rollers are coupled to an arm positioned in a parallel vertical plane to the vertical plane of the clamping mechanism and the motor drives the rollers from one end of the flexible tube to the other end along the arm.

In some embodiments, wherein the means for mixing comprises an array of fingers arranged on opposite sides of the flexible tube, wherein opposite pairs of fingers are sequentially driven towards each other and into an exterior wall of the flexible tube.

The above description, as well as additional objects, features, and aspects of the disclosed embodiments, will be more fully appreciated by reference to the following detailed description, including the accompanying drawings.

### BRIEF DESCRIPTIONS OF THE DRAWINGS

The detailed description particularly refers to the accompanying figures in which:

FIG. 1 is a perspective view of the disclosed embodiments illustrating a system including a flexible tube placed within a mixing rollers apparatus;

FIG. 2A-2C are a side sectional views of various roller configurations;

FIG. 3A is side sectional view showing the device to adjust roller pressure on the apparatus described in FIG. 1;

FIG. 3B is a side sectional view showing the invention with flexible tube stationary and the rollers moving;

FIG. 4 is an alternative embodiment that uses activated fingers instead of rollers;

FIG. 5 shows an embodiment with a camera mounted on the apparatus of FIG. 1;

and

FIG. 6 shows an embodiment with a single roller.

### DETAILED DESCRIPTION

The need to manufacture personalized beauty and health care formulations requires new methods and apparatus for the formulation of these very small volumes ranging from 5 ml to 100 ml.

Moreover, these formulations may require the addition of numerous ingredients to a lotion or cream base. These additions should be made under sterile conditions to minimize any potential contamination. This is very difficult to do in an uncontrolled environment, such as in-home or at a beauty counter. Since the formulation may be made at point-of-use it is also necessary for the consumer to be able to instantly tell if the formulation is completely mixed and homogenous.

This invention uses disposable flexible tubes for formulation. The lotion, cream, or ointment base is filled into a tube of suitable volume. It is critical that the tube not be filled completely (10 to 60% full). The remaining volume must be evacuated. This tube is typically filled at a formulation facility in large quantities using conventional formulation technology. The partially filled tubes are then sent to the point-of-use centers and constitute the base of the custom formulations. The flexible tubes are typically capped with a fitting that permits the additions of ingredients with a either a needle or needle-less injection system. Such caps are commonly used in the medical industry and have been well proven to provide a sterile connection even in uncontrolled environments. An example of a needle-less connector is the Clave (ICU Medical). Ingredients may added and mixed as described in the next paragraph individually, or together depending on formulation requirements.

Mixing is performed by inserting the tube in a device containing multiple rollers. Once the tube is inserted, mixing is initiated by triggering the rollers to move the tube back and forth. This motion forces fluid to be pushed from the top to the bottom and then in the reverse direction. This motion rapidly mixes the formulation. The rheology of the formulation is of no consequence and gels and viscous ointments can be as easily mixed as water-like fluids. In this particular embodiment, the tube is moved past through stationary rotating rollers. Alternatively, the tube could be held stationary and the roller moved back and forth as they rotate. The mixing action is the same—the key feature is that the tube must partially filled so that the contents can be squeezed from one end of the tube to the other and then back again.

Use of single-use flexible tubes eliminates the need for cleaning and concern of cross-contamination. The tube partially filled with base may be provided clean or sterile depending on requirements. Addition of ingredients using medically certified connectors ensures that these ingredients may be added by users with minimal training in an uncontrolled environment. Ingredients may be dosed using needle-less disposable syringes. Swabbing the connectors with alcohol between additions ensures sterile operation. Alternatively, simple automated dispensing equipment can be used to connect and add the required ingredients.

The contents of the formulation tube are mixed by this non-invasive device. The materials being mixed are never exposed to the air or the environment. This eliminates any concern about microbial contamination or oxidation. The non-invasive mixer can mix a diverse number of formulations without any fear of cross-contamination as the mixing elements never contact the formulation. The flexible tube, the cap, and the connector fitting are configured to be a sterile storage container for the resultant uniform formulation so that the completed mixture does not need to be transferred to an a different container and additional caps or connectors are not needed to seal the mixed formulation.

It is difficult to mix to obtain a homogeneous formulation based on a fixed mixing time as it takes longer to mix a viscous cream than an aqueous solution. It is especially difficult in an uncontrolled environment with unskilled personnel. One of the embodiments envisions using suitably dyed ingredients. A camera can be provided that monitors the formulation as it is mixed and assesses uniformity of color in real time. When the color is homogeneous it indicates that the dye has been dispersed and the mixing is complete. A dye may not be necessary if the components to be mixed have different colors or other optically detectable properties.

Thus, in accordance with the disclosed embodiments, systems and methods for the mixing of small volume formulations that can operate in uncontrolled environments and with unskilled labor or minimal automation. Thus, the system provides a container and an apparatus that eliminates cleaning, allowing sterile addition of ingredients and can non-invasively mix any fluid ranging from aqueous solutions to pastes. Finally, the apparatus must be easy to use and economical to operate.

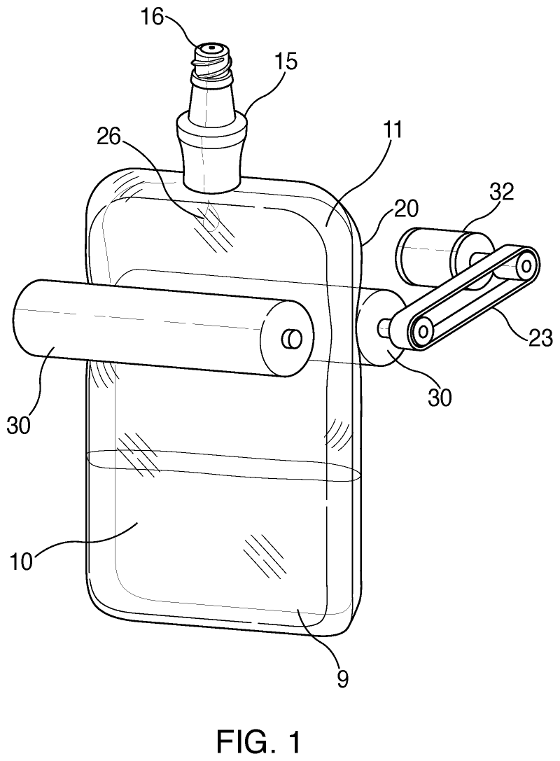

Referring now to the drawings, wherein like reference numerals and characters represent like or corresponding parts and steps throughout each of the views, there is shown in FIG. 1 a perspective view of an embodiment showing a mixing system having a flexible tube 20 containing the formulation base 10 placed inside rollers 30. The flexible tube may only be partially (10 to 60%) filled with the formulation base 10 so that it is squeezed from one end of the tube 20 to the other end of the tube 11 when the tube 20 is moved by pinch rollers 30. The pinch rollers 30 may be actuated by motor 32 coupled to belt 23 that rotates pinch rollers 30 in one direction and then in the opposite direction as indicated by arrows. This causes tube 20 to move up and down as indicated by the arrows. Limits may be set so that the tube stays within the pinch rollers at all times. The flexible tube can be made of various suitable materials and may be a transparent material. The tube 20 may be flexible and not impart any flavors or color to the formulation. The tube 20 may have a flat profile so that it is squeezed by the pinch rollers. A cap 15 closes the flexible tube 20. In some embodiments, a syringe adaptor 16 is provided on cap 15 so that additions, or ingredients 26, to be mixed into the base formulation 10 may be made by connecting a syringe or tube containing the required ingredients. These can be then be injected into the base formulation 10.

Once the flexible tube 20 containing the base formulation 10 is in position between the pinch rollers 30, ingredients 26 to be mixed into the base formulation 10 are introduced through adaptor 16. Ingredients 26 may be added sequentially and mixed sequentially, or added together and mixed in one operation. Mixing is performed by activating the pinch rollers 30. The back and forth movement of the tube 20 between the pinch rollers 30 forces the contents, such as ingredients 26 and the formulation 9, to be kneaded to rapidly form a homogeneous mixture.

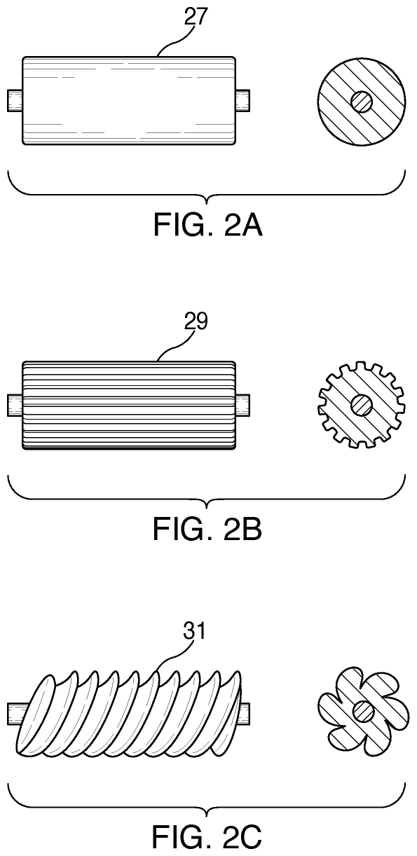

Pinch rollers 30 may have different configurations as shown in FIG. 2. Various grooving schemes may promote better mixing. For example, the spiral groove 31 design shown in FIG. 2 C is particularly effective in mixing pastes, gels, and similar viscous materials. Alternative grooving schemes include linear parallel grooves 29, as shown in FIG. 2B, or a uniform surfaced roller with no grooves 27 as shown in FIG. 2A.

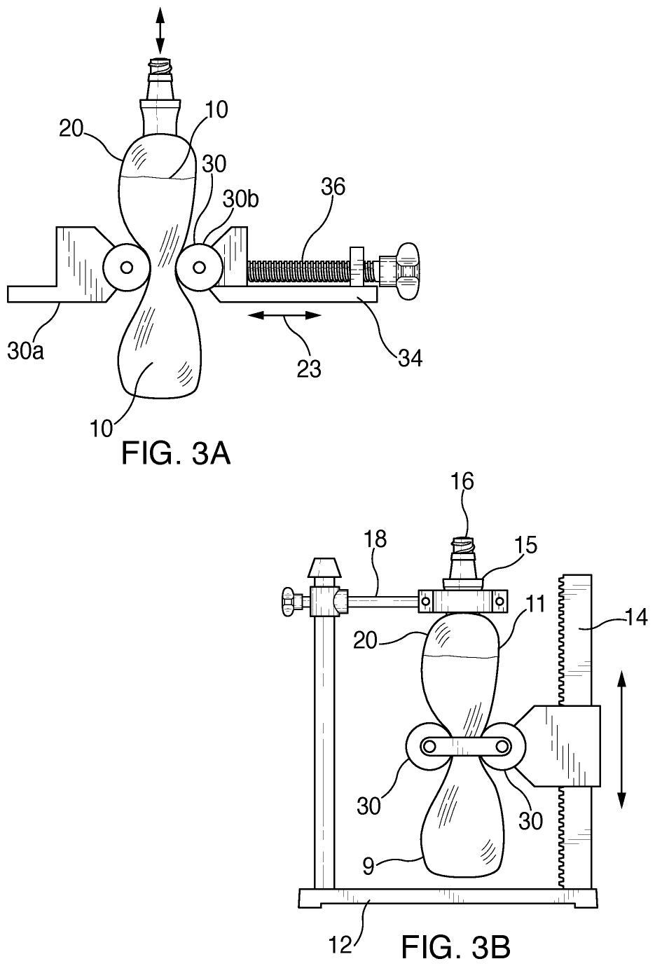

The spacing of the pinch rollers 30 can be adjusted by a screw arrangement 36 as shown in FIG. 3A. In this embodiment, roller 30a is kept at a constant position. Roller 30b automatically adjusts in the horizontal axis direction view screw arrangement 36 to accommodate flexible tube 20 in the space between rollers 30a, 30b. Screw arrangement 36 includes a screw 34 mounted to an arm 23 of roller 30b so that screwing the screw in one direction moves the roller 30b closer to roller 30a, and screwing it in the opposite direction moves roller 30b away from roller 30a. This allows the pinch rollers 30 to conform to flexible tube 20 of varying thickness.

In another embodiment shown in FIG. 3 B, the pinch rollers may be moved from one end 9 of the flexible tube to the other end 11 while the flexible tube 20 is held stationary below the cap 15 by fixed arm 18, with a clamping mechanism such as adjustable clamp for example, coupled to a base 12. Rollers 30 may be driven by a motor to move up and down as indicated by arrows along a rack and pinion shaft 14, which may also be coupled to the base 12. This is in contrast to the earlier embodiment where the rollers were stationary. Embodiments are shown with motion in the vertical plane but this orientation can be in the horizontal, or any plane.

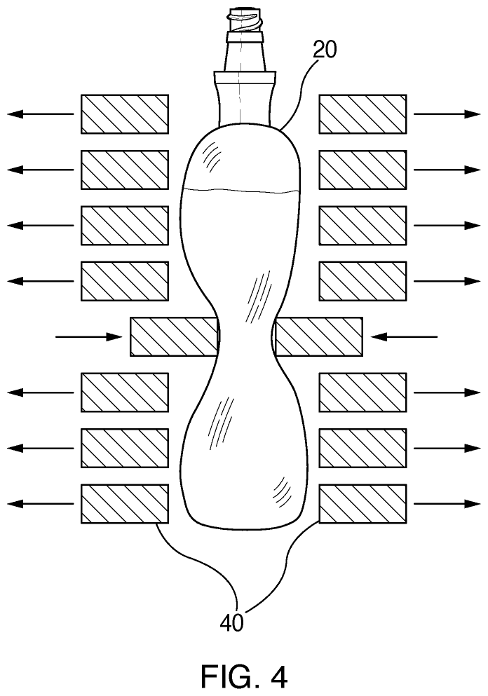

FIG. 4. shows an embodiment that uses an array of fingers 40 positioned on opposite sides of the flexible tube 20. The array of fingers 40 may be triggered sequentially in pairs into an exterior sidewall of the flexible tube 20 to squeeze the flexible tube 20 along its axis to provide the necessary reciprocating mixing motion. Other similar, electrical or pneumatic mechanisms can be employed.

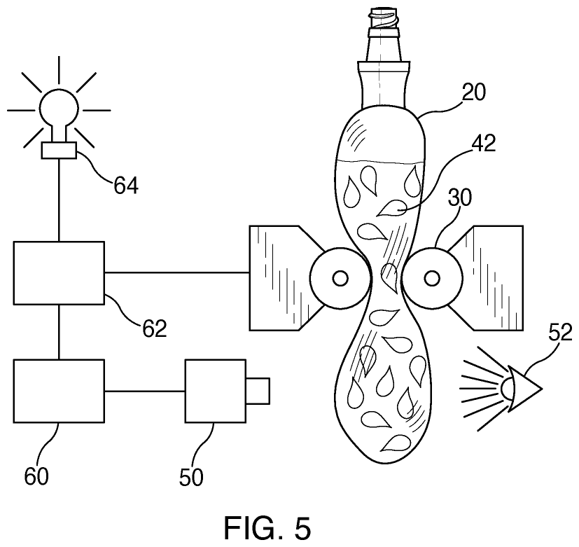

Homogeneity of the formulation 42, formed by the base formulation and one or more added ingredients, can be monitored by a camera 50 as shown in FIG. 5. A light source 52 can be used to enhance contrast. The mixing can be automatically stopped, and the user alerted when the camera determines that the color of the formulation 42 is uniform. Camera 50 is connected to microprocessor 60 that analyzes the pixel image from the camera and determines if the image is uniform based on a user-set tolerance. If the mixture is judged to be uniform the microprocessor sends a signal to the motor controller 62 to stop the motors and unload the flexible tube. An indicator 64 is also triggered to alert the user that the mixing process is complete. Camera 50, microprocessor 60, and motor controller 62, may be used to control any of the roller configurations disclosed.

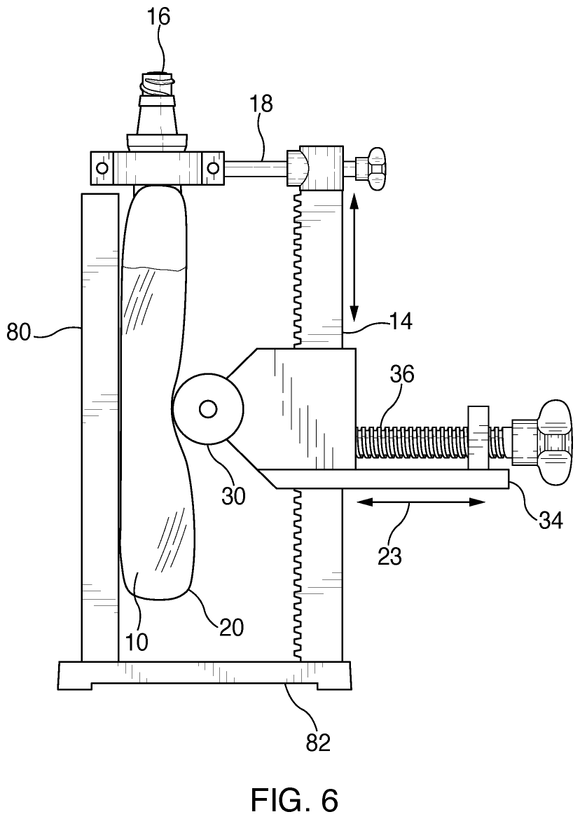

FIG. 6 shows an alternate embodiment that utilizes a single roller instead of the dual rollers described in previous embodiments. A flat plat 80 is positioned against roller 30. The flexible tube 20 is placed between flat plat 80 and roller 30. Roller 30 is moved up and down on rack-and-pinion 14 to mix the contents 10 inside flexible tube 30 as described earlier. Screw 36 located on clamp 34 can be adjusted (23) to modulate the force on flexible tube 30. Stand 82 supports the mechanism and arm 18 holds the flexible tube 30 from moving while roller 30 is activated.

Though the disclosed embodiment has been described by way of a detailed description in which various embodiments and aspects of the invention have been described, it will be seen by one skilled in the art that the full scope of the invention is not limited to the examples presented herein.

1. A mixing system for mixing small volume formulations at a point-of-use center, the mixing system comprising:
a flexible tube comprising a volume of a base formulation that is less than a volume of the flexible tube,
a connector configured for one-way introduction of one or more external ingredients into the flexible tube while maintaining a sterile condition inside the flexible tube, and
means for mixing the base formulation and the one or more external ingredients by applying a predetermined and varying pressure from one end of the flexible tube to another end so that the resulting formulation is uniform.

2. The mixing system of claim 1, wherein the means for mixing comprises one or more rollers coupled to a motor and configured to provide rolling pressure from one end of the flexible tube to another other end of the flexible tube.

3. The mixing system of claim 2, wherein the means for mixing further comprising a camera configured sense homogeneity of the mixture to stop the motor and corresponding movement of the rollers when the resulting formulation is determined to be uniform.

4. The mixing system of claim 2, wherein the one or more rollers comprises two rollers that are fixed in a vertical plane and the flexible tube is suspended and supported by the rollers, wherein in response to the rollers rotating in one direction, the flexible tube moves longitudinally in a direction opposite the one direction.

5. The mixing system of claim 2, wherein the flexible tube is fixed in a vertical plane via a clamping mechanism, and two rollers are coupled to an arm positioned in a parallel vertical plane to the vertical plane of the clamping mechanism and the motor drives the rollers from one end of the flexible tube to the other end along the arm.

6. The mixing system of claim 1, wherein the means for mixing comprises an array of fingers arranged on opposite sides of the flexible tube, wherein opposite pairs of fingers are sequentially driven towards each other and into an exterior wall of the flexible tube.

7. The mixing system of claim 1, wherein the connector comprises a sterile connector configured to provide one-way access for a needle to be inserted to inject the one or more external ingredients into the flexible tube and provide a barrier to the external environment when the needle is no longer inserted in the connector.

8. The mixing system of claim 1, wherein the connector comprises a needleless injector sterile connector configured to provide one-way access to a needleless injector to inject the one or more ingredients into the flexible tube and prove a barrier to the external environment when the needleless injector is no longer inserted into the connector.

9. The mixing system of claim 1, wherein the flexible tube, the cap, and the connector are configured to provide a sterile storage container for the resultant uniform formulation.

10. A mixing system for mixing small volume formulations, the mixing system comprising:
a flexible tube comprising a volume of a base formulation that is less than a volume of the flexible tube,
a connector configured for introduction of one or more external ingredients into the flexible tube, and
pinching rollers configured to be driven along an external sidewall of the tube to apply pressure from one end of the tube, along the tube, to an opposite end of the tube and reverse the pressure application repeatedly until a resulting formulation is uniform.

11. The mixing system of claim 10, wherein the system further comprises a camera positioned exterior to the flexible tube and configured to stop the pinching rollers when the camera senses that the mixture is uniform.

12. The mixing system of claim 11, wherein the system further comprises a light source positioned exterior to the flexible tube and opposite the camera.

13. The mixing system of claim 12, wherein a control is configured to determine that the mixture is uniform, stop the pinching rollers, and alert a user.

14. The mixing system of claim 11, wherein the pinching rollers comprise two rollers that are fixed in a vertical plane, wherein the flexible tube is suspended and supported by the rollers, wherein in response to the rollers moving in one direction, the flexible tube moves in a direction opposite the one direction.

15. The mixing system of claim 10, wherein the remainder of the volume of the flexible tube unfilled by the base formulation is evacuated.

16. The mixing system of claim 15, wherein the connector comprises a sterile connector configured to provide one-way access for a needle to be inserted to inject the one or more external ingredients into the flexible tube and provide a barrier to the external environment when the needle is no longer inserted in the connector.

17. The mixing system of claim 15, wherein the connector comprises a needleless injector sterile connector configured to provide one-way access to a needleless injector to inject the one or more ingredients into the flexible tube and prove a barrier to the external environment when the needleless injector is no longer inserted into the connector.

18. The mixing system of claim 10, wherein the flexible tube, the cap, and the connector are configured to provide a sterile storage container for the resultant uniform formulation.
